(19) United States
(12) Patent Application Publication
(10) Pub. No.: US 2011/0213830 A1
(43) Pub. Date: Sep. 1, 2011

(54) CLOUD-BASED INTELLECTUAL PROPERTY AND LEGAL DOCKETING SYSTEM AND METHOD WITH DATA MANAGEMENT MODULES

(76) Inventors: Kermit D. Lopez, Albuquerque, NM (US); Luis M. Ortiz, Albuquerque, NM (US); Richard H. Krukar, Albuquerque, NM (US)

(21) Appl. No.: 12/976,010

(22) Filed: Dec. 22, 2010

Related U.S. Application Data
(60) Provisional application No. 61/308,507, filed on Feb. 26, 2010.

(51) Int. Cl. G06F 15/16

(52) U.S. Cl. 709/203

(57) ABSTRACT

An intellectual property docketing and management method and system. A network server is associated with a SaaS (Software as a Service) docketing module and a database for storing docket matters, such as data associated with patent and/or trademark filings before the U.S. Patent & Trademark Office. The network server can be accessed over a data network (e.g., the Internet) via at least one remote client to enter, update and review via said docketing module, the status of docket matters sorted and stored in said database by said docketing module by at least a client name, a client docket number, an activity and a target date for completion of said activity. A client matter status can be automatically delivered at predetermined intervals via network automated and electronic delivery from said network server to said at least one remote client via said docketing module.

### CROSS-REFERENCE TO PROVISIONAL APPLICATION

This nonprovisional patent application claims the benefit under 35 U.S.C. § 119(e) of U.S. Provisional Patent Application Ser. No. 61/308,507 filed on Feb. 26, 2010, entitled “Cloud-Based Intellectual Property and Legal Docketing System and Method with Data Management Modules,” which is hereby incorporated by reference in its entirety.

### TECHNICAL FIELD

Embodiments are generally related to the field of computers and similar technologies and, in particular, to software utilized in this field. Embodiments are additionally related to SaaS (Software as a Service) and computer networks and cloud computing applications. Embodiments are also related to intellectual property docketing methods and systems, including those that are capable of docketing/tracking patent and trademark matters filed with the U.S. Patent & Trademark Office and other intellectual property agencies, such as, for example, the European Patent Office.

### BACKGROUND OF THE INVENTION

Docketing systems have historically included a calendar and a pencil as components. A lawyer or paralegal or secretary, acting as a docketer, identified a docket event in writing, on an appropriate date designation of the calendar. The docketer typically included reminder notes on the calendar in advance of a docket event. Docket events included dates such as a due date or a bar date or a court date.

The calendar and pencil have largely been supplanted or replaced by software that functions as an electronic calendar. The software includes a library of events that are typically the objects of a docket. The library also includes rules associated with the events. To use the software, a docketer identifies a particular matter, selects an event from the library and enters a significant date into the software. The significant date is one that the docketer desires to associate with the date, for the matter. The docketer enters data by using a keyboard and transferring information from a document to the software. The software activates rules associated with the event to generate significant docket dates. Some docketing software products automatically generate reminder dates in conjunction with the significant docket date. Docketers generate reports using the software. The reports provide a summary of docket dates and events associated with the dates for selected matters.

Docketers typically employ the calendar and pencil as a backup docket system, even though the docketers use the software as a primary system. The dual use insures that important docket dates are not lost.

In practicing intellectual property law, practitioners are often confronted, in each case, with meeting a bewildering number of due dates, many of which are critical. These myriad due dates are prescribed by Title 15 of the United States Code (for trademark matters), Title 17 of the United States Code (for copyright matters), and Title 35 of the United States Code (for patent matters). Additional deadlines are imposed by the Code of Federal Regulations (e.g., Title 37 of the Code of Federal Regulations which applies to patent and trademark matters), the Federal Rules of Civil Procedure, and various published Court rules. Yet other deadlines are imposed by clients or by corporate business objectives.

Each patent or trademark application handled by an attorney, for example, requires the docketing and meeting of one or more deadlines. For example, a typical utility patent application may impose a dozen or more time deadlines on a practitioner over the course of its prosecution. While some due dates may merely be reminders to take some action, others are critical deadlines (i.e., prescribed by statute) and failure to timely act prior to these so-called “statutory bar dates” may result in the loss of valuable intellectual property rights or in a legal malpractice claim against the practitioner.

Typical actions, which may be docketed and performed by a practitioner in evaluating an invention for patentability, preparing, filing and prosecuting a utility patent application, or in tracking actions anticipated to be taken by the Patent Office, are as follows: Conduct novelty search on invention Prepare patentability opinion File patent application before one year statutory bar (sale, public use or publication) Receive acknowledgment postcard from USPTO Receive official filing receipt and foreign filing license Send Rule 56 Duty of Disclosure letter to inventor(s) File Information Disclosure Statement Respond to First Office Action Send foreign filing letter to client Foreign file before deadline to receive priority filing date Respond to Second Office Action File Notice of Appeal File Appeal Brief File formal drawings Pay Issue Fee Pay Maintenance Fee(s)

A similar number of actions are tracked and docketed for trademark matters, and a lesser number of actions (i.e., renewals) are tracked for copyrights. Similar actions are also tracked for foreign matters (patent and trademark applications filed in foreign countries), and in inter partes proceedings (e.g., trademark oppositions and cancellation proceedings). It is clear, then, that even a relatively small law firm or company handling a portfolio of just a few hundred cases can easily be confronted with tracking and docketing tens of thousands of due dates for actions to be taken, either by the practitioner or the Patent Office. Large firms or companies may be faced with docketing more than a hundred thousand dues dates and actions.

In earlier times, patent and trademark attorneys relied on manual docketing systems, which involved complicated manual ledger, and/or tickler systems for tracking actions to be taken and deadlines to be met. These systems required constant attention and vigilance, highly trained docketing clerks and administrators, and direct supervision by attorneys. Often, the systems included redundancy to ensure that dates were not missed, which redundancy provided added protection at the expense of efficiency. Obviously, any manual system cannot be operated flawlessly. All humans make mistakes. Moreover, the opportunity for error increases as the number of files being maintained increases. Despite well-documented procedures, cross-checking and vigilance, all manual systems are susceptible to failure. They are especially problematic when employees leave, and new employees are forced to learn the system.

Commercially available IP docketing software products enable users to keep track of actions and due dates associated therewith. Some automatically calculate certain due dates for actions to be taken or annuities, maintenance fees, taxes, or other fees to be paid. Some also are preprogrammed with the laws and rules of multiple countries. All commercially available products provide “docket reports” detailing (usually in chronological order) actions required to be taken by a responsible attorney. Often, these reports are compiled and printed on a periodic basis (e.g., weekly) and distributed to responsible attorneys. In a well-designed system, a docket administrator or managing attorney will also receive a “master” docket report, to monitor all critical due dates.

A number of software products for docketing matters are known. For, example, U.S. Pat. No. 7,369,701, which is incorporated herein by reference and entitled “Automated Docketing System” describes a method for docketing an action or event, such as an action or event defined in a form received from the United States Patent and Trademark Office. The method includes scanning the form having written information thereon, the written information comprising a date and indicia defining a docket event, to obtain a scanned image. The indicia on the form defining a docketing event includes a title such as, “Office Action,” “Notice of Allowance,” “Notice of Missing Parts” and so forth. The date on the form includes, in many embodiments, “Date Mailed.” The method also includes processing the scanned image with character recognition logic and identifying the indicia defining the docket event or action and the date on the image. One of the problems with the approach disclosed in U.S. Pat. No. 7,369, 701 is a lack of easy accessibility and user-friendly features, particularly to small law firms and solo-practitioners.

Another docketing system is disclosed in U.S. Pat. No. 6,549,894, entitled “Computer Docketing System for Intellectual Property Law With Automatic Due Date Alert” and which is incorporated herein by reference. The approach described in U.S. Pat. No. 6,549,894 generally includes a computerized docketing system for legal matters, comprising a database operatively arranged to store information related to the legal matters, including actions to be taken with respect to the legal matters, and due dates associated with the actions to be taken, an arithmetic logic unit operatively arranged to scan the database, compare each of the due dates with a reference date, and classify the due dates according to proximity of each of the due dates to the reference date, and, means for displaying different classifications of the due dates in different colors for the purpose of alerting a user of the system of matters requiring attention. Such a system, while offering certain advantages as a standalone package, cannot be easily adapted to a cloud-based computing system and must be operated internally from an organization server rather than being capable of offering via a cloud-based Internet and/or (SaaS) application.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved legal and intellectual property docketing and management method and system.

It is another aspect of the disclosed embodiments to provide for an improved intellectual property docketing and management method and system accessible via a computer network such as the Internet.

It is a further aspect of the disclosed embodiments to provide for a “cloud based” computing intellectual property docketing and management method and system having family tree generation features and capabilities thereof.

It is another aspect of the disclosed embodiments to provide for a SaaS (Software as a Service) intellectual property docketing and management method and system.

The aforementioned aspects and other objectives and advantages can now be achieved as described herein. A docketing and management method and system is disclosed, which generally includes a network server associated with a docketing module and a database for storing docket matters. The network server can be accessed over a data network via at least one remote client to enter, update and review via the docketing module, the status of docket matters sorted and stored in the database by the docketing module by at least a client name, a client docket number, an activity and a target date for completion of the activity. Additionally, a client matter status can be automatically delivered at predetermined intervals via network automated and electronic delivery from the network server to one or more remote clients via the docketing module.

The docketing module is preferably offered as a SaaS (Software as a Service), component, which is a model of software deployment whereby a provider licenses an application to customers for use as a service on demand. SaaS software vendors may host the application on their own web servers or upload the application to the consumer device, disabling it after use or after the on-demand contract expires. The on-demand function may be handled internally to share licenses within a firm or by a third-party application service provider (ASP) sharing licenses between firms.

In accordance with another embodiment, a secure identification (e.g. password, username, etc) can be established with a family of the docket matters stored in the database; and an authorized party provided with secure and remote access to the family of docket matters based on the secure identification. The secure identification can be entered via the at least one remote client and the remote access is preferably read-only. Additionally, the remote access to the family of the docket matters can include access to scanned images of documents comprising a file wrapper associated with at least one of the docket matters.

In another embodiment, access to one or more active forms associated with a government agency responsible for intellectual property matters can be provided to a user, wherein such form(s) are accessible from the network server via the docketing module.

In still another embodiment access can be provided for a user to one or more active forms associated with a government agency responsible for intellectual property matters. The active form(s) are accessible from the network server via the docketing module. Such active form(s) can be populated with identifying information from a particular docket matter among the docket matters after association of the active form(s) with the particular docket matter.

In yet another embodiment, a family tree can be generated, wherein such a family tree is associated with a family of docket matters. For example, in such a situation, a “family” of docket matters may include a parent patent application followed by several “child” applications such as a first continuation patent application, a second continuation application, a CIP based on the first continuation patent application and so forth. Such a family tree can be generated and then displayed for a user via a display such as display screen of a computer workstation, laptop computer, Smartphone, and so forth. Docket matters can include, for example, patent related docket matters and the aforementioned family tree can be rendered based on docketing matter filing dates and continuation status and other data such as issue dates, titles, filing information, bar dates, due dates, priority dates and so forth.

In some embodiments, the aforementioned authorized party can be a client of a law firm and the remote access to the family of docket matters cab be provided to the client of the law firm via a website associated with the law firm and/or hosted/sponsored by the law firm or an appropriate website hosted by an Internet Service Provider (ISP) on behalf of the law firm.

In another embodiment, the docketing module can receive at least one e-mail message regarding case status from a government agency, identify a docket matter from the at least one e-mail message based on at least one of a serial number or docket number, and automatically update the docket matter with the case status, the docket matter among the docket matters.

In yet another embodiment, the docketing module can automatically retrieve one or more electronic documents from the government agency based on the case status provided by the at least one e-mail message and store the electronic document(s) in a database in association with the docket matter. The docketing module can be configured to identify one or more legal representatives (e.g., patent attorneys, patent agents, paralegals, etc) responsible for the docket matter and automatically e-mail the case status to the legal representative. The docketing module can be configured to identify one or more legal representative responsible for the docket matter and automatically e-mail the case status to the legal representative(s) along with the electronic document(s) retrieved from the government agency. Additionally, the docketing module can be configured to receive e-mail messages regarding case status from a government agency, identify a docket matter from the e-mail message based on a serial number or a docket number, and identify a responsible legal representative to be notified regarding the case status and then automatically update the docket matter with the case status.

In another embodiment, a law firm client can be authorized to upload to the network server via the docketing module, one or more documents associated with one or more docket matters, wherein the docket matter (s) is associated with the law firm client. The preauthorized law firm client can also be provided with secure access an electronic invention disclosure form via the docketing module from the law firm website using a secure identification code. The preauthorized law firm client can be authorized via the docketing module to enter information regarding a new invention into the electronic invention disclosure form. A new docket number can be automatically assigned to the electronic invention disclosure form when the electronic invention disclosure form is saved in the database via the docketing module.

In yet another embodiment, authorized law firm personnel can be permitted, via the docketing module, to upload and save an electronic document to the database, wherein the electronic document is associated with at least one docket matter among the aforementioned docket matters.

In still another embodiment, the docketing module can be configured to track the time of law firm personnel associated with work on a docket matter or a group of docket matters. In yet another embodiment, the docketing module can be configured to generate a total amount of time spent on one or more docket matters at predetermined date(s) and time(s). The docketing module can then designate such time as constituting billable time or non-billable time. An invoice can be then automatically generated and sent to a client of the law firm based on the billable time.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a data-processing system in which the present invention may be embodied;

FIG. 2 illustrates a schematic view of a software system including an operating system, application software, and a user interface for carrying out the present invention;

FIG. 3 illustrates a graphical representation of a network of data processing systems in which aspects of the present invention may be implemented;

FIGS. 4-12 illustrate a high-level flow chart depicting logical operational steps of a docketing and management method, which can be implemented in accordance with the disclosed embodiments; and

FIGS. 13-14 illustrates a pictorial representation of a browser configured to display a docketing application including the generation of a docketing family tree, in accordance with the disclosed embodiments; and

FIG. 15 illustrates a block diagram of a cloud-based intellectual property docketing system, in accordance with the disclosed embodiments.

### DETAILED DESCRIPTION

The particular values and configurations discussed in these non-limiting examples can be varied and are cited merely to illustrate at least one embodiment and are not intended to limit the scope of such embodiments.

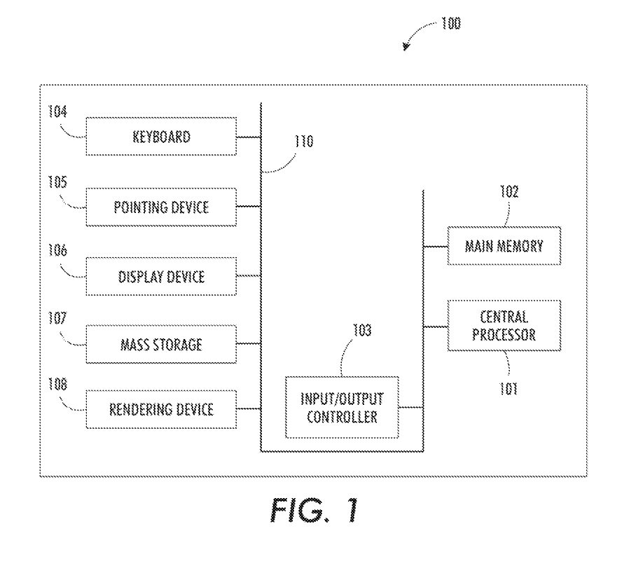

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention. Additionally, in FIGS. 1-15 herein, like or identical parts or features are generally indicated by identical reference numerals.

As depicted in FIG. 1, embodiments may be implemented in the context of a data-processing system 100 that generally includes a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108, may be included in the data-processing system 100 as desired. Note that the rendering device 108 may constitute, for example, a printer, a copier, fax machine, scanner, and/or other types of rendering components, depending upon design considerations. Note that although the discussion herein refers to a rendering device 108, other types of devices may also be utilized in place or in addition to rendering device 108. Examples of such devices including feeding devices and/or finishing devices, depending upon design considerations. As illustrated, the various components of the data-processing system 100 can communicate through a system bus 110 or a similar architecture, including, for example a USB (Universal Serial Bus) and USB components.

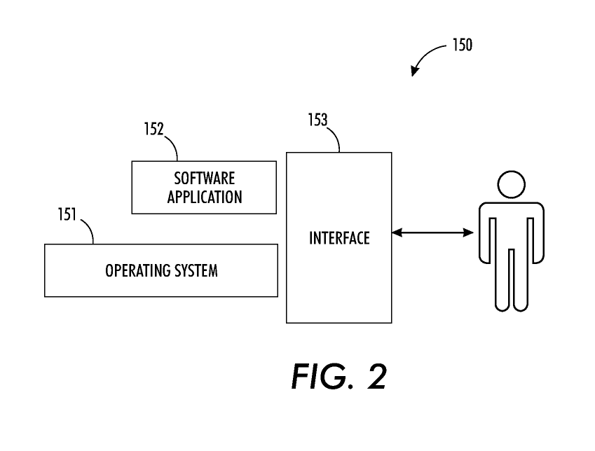

FIG. 2 illustrates a computer software system 150 for directing the operation of the data-processing system 100 depicted in FIG. 1. Software system 150, which is stored in system memory 102 and on disk memory 107, can include a kernel or operating system 151 and a shell or interface 153. One or more application programs, such as application software 152, may be “loaded” (i.e., transferred from storage 107 into memory 102) for execution by the data-processing system 100. The data-processing system 100 can receive user commands and data through user interface 153; these inputs may then be acted upon by the data-processing system 100 in accordance with instructions from operating module 151 and/or application module 152.

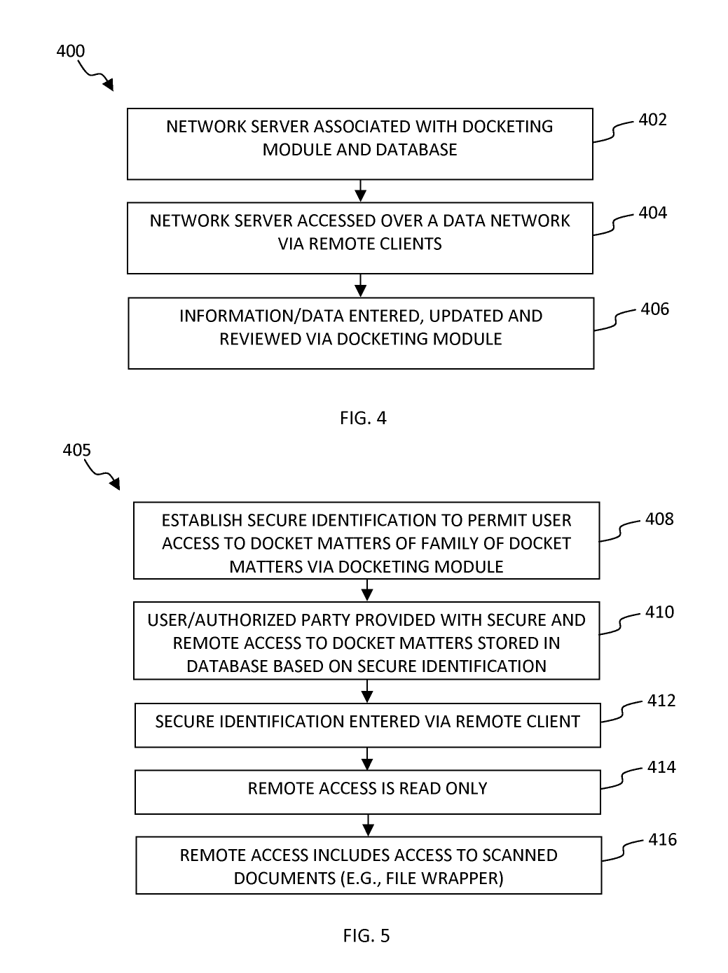

The interface 153, which is preferably a graphical user interface (GUI), also serves to display results, whereupon the user may supply additional inputs or terminate a given session. In one possible embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. Application module 152 can include computer program code comprising instructions executable by a processor (e.g., processor 101 of FIG. 1) and configured for processing various operations such as those, for example, depicted herein with respect to FIGS. 4-12.

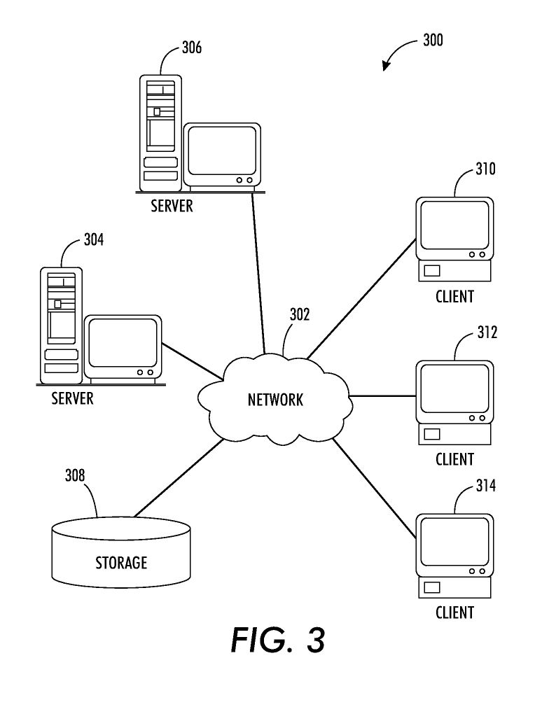

FIG. 3 illustrates a graphical representation of a system 300 in which embodiments may be implemented. System 300 can be implemented as a data network (e.g., the Internet) of computers. System 300 contains, for example, network 302, which is the medium used to provide communications links between various devices and computers connected together within network data processing system 100. Network 302 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing system 100 depicted in FIG. 1 can be, for example, a client such as client 310, 312, and/or 314. Alternatively, data-processing system 100 can be implemented as a server such as servers 304 and/or 306, depending upon design considerations.

In the depicted example, server 304 provides data such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers which provide equivalent content.

In the depicted example, system 300 can be the well-known Internet with network 302 representing a worldwide collection of networks and gateways that use the Transmission Control Protocol/Internet Protocol (TCP/IP) suite of protocols to communicate with one another. At the heart of the Internet, for example, is a backbone of high-speed data communication lines between major nodes or host computers, consisting of thousands of commercial, government, educational, and other computer systems that route data and messages. Of course, system 300 also may be implemented as a number of different types of networks such as, for example, an intranet, a local area network (LAN), a wireless network, a wide area network (WAN), and so forth. Note that FIGS. 1-3 are intended as an example and not as an architectural limitation for different embodiments of the present invention.

The disclosed description is presented with respect to embodiments of the present invention, which can be embodied in the context of a data-processing system such as data-processing system 100 and computer software system 150 depicted respectively FIGS. 1-3. The disclosed embodiments, however, are not limited to any particular application or any particular environment. Instead, those skilled in the art will find that the system and methods of the present invention may be advantageously applied to a variety of system and application software, including database management systems, docketing systems, word processors, spreadsheets, and the so forth. Moreover, the disclosed embodiments may be embodied on a variety of different platforms, including Macintosh, UNIX, LINUX, and the like. Therefore, the description of the exemplary embodiments, which follows, is for purposes of illustration and not considered a limitation.

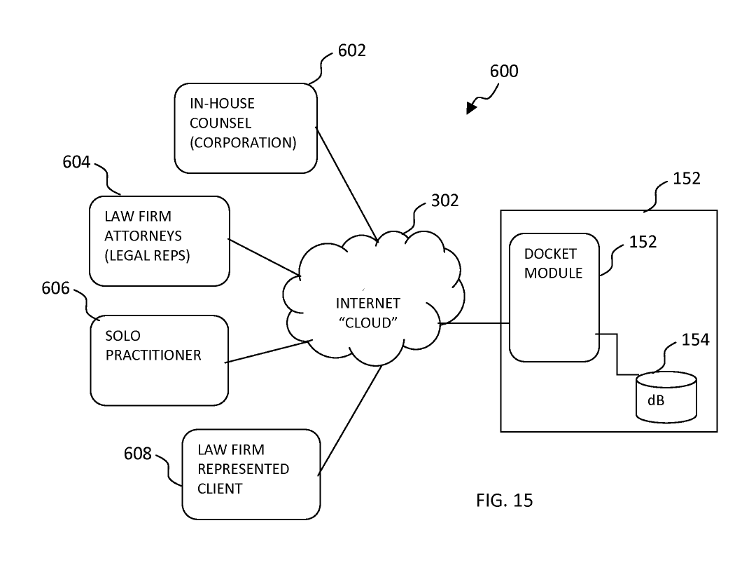

Server 304 and server 306 and other servers (not shown) can be configured to act as redundant servers. That is, servers 304 and 306 (and other servers) can communicate with one another via the “cloud” or network 302 (e.g., see the Internet cloud 302 shown in FIG. 15). In this manner, data stored in server 304 can be synchronized with data stored in server 306 and/or other servers, so that if one server goes down the other server or servers can contain the same data and one does not need to worry about a loss of data. In some embodiments, server 306 may be located geographically in a distant location (e.g., the East Coast) from the other server 304 located at a different position (e.g., the West Coast).

Embodiments herein sometimes refer to the use of or more “modules” in the context of a data-processing system, data network, database and/or remote clients such as those depicted in FIG. 3. Note that instructions outlined herein can be implemented in the context of such “modules”. In the computer programming arts, a “module” can be typically implemented as a collection of routines and data structures that performs particular tasks or implements a particular abstract data type. Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. One or modules can be therefore be implemented to process, for example, the instructions discussed herein with respect to FIGS. 4-12. Note that the operations indicated in FIGS. 4-12 can be implemented by executing a program instruction in a data-processing system, such as, for example, system 100.

Thus, for example, embodiments herein utilize a docketing module. Such a docketing module is a software module can be implemented as computer software for use in scheduling and managing legal matters, and in particular, intellectual property legal matters, such as patent, trademark and copyright matters. The docketing module discussed herein can function as matter management or case management software, although generally the term docketing software refers to intellectual property software applications. The disclosed docketing module can manage aspects of the intellectual property (IP) assets of a business organization, including patents, trademarks, licenses and royalties.

FIG. 4 illustrates a high-level flow chart depicting logical operational steps of a docketing and management method 400, which can be implemented in accordance with the disclosed embodiments. As indicated at block 402 a network server (e.g., servers such as servers 304, 306) is associated with a docketing module and a database (e.g., a database such as database 308 shown in FIG. 3) for storing docket matters (e.g., data associated with dockets, including, for example, docket numbers, serial numbers, client reference numbers, titles, inventor names, priority dates, due dates, bar dates, country priority information, assigned attorney, paralegal, client name, addresses, e-mail addresses, phone numbers, and so forth). Next, as illustrated at block 404, the network server can be accessed over a data network (e.g., a network such as network 302 shown in FIG. 3) via one or more remote clients. Then, as indicated at block 406, information and other data can be entered, updated and reviewed via the docketing module. Such information may include, for example, the status of docket matters sorted and stored in the database by the docketing module by for example, but not limited to, a client name, a client docket number, an activity and a target date for completion of the activity, and so forth. Thereafter, as illustrated at block 406, an operation can be implemented for automatically delivering client matter status information at predetermined intervals via network automated and electronic delivery from the network server to one or more of the remote clients via the docketing module.

FIG. 5 illustrates a high-level flow chart depicting additional logical operational steps of a docketing and management method 405, in accordance with the disclosed embodiments. The operational steps depicted in FIG. 5 can include, for example, the step of establishing a secure identification (e.g. password, username, etc) for a user that permits the user to access the docketing module and hence docket matters (e.g., individual docket matters, a family of docket matters, etc) stored in the database, as depicted at block 408. Such a user may be, for example, a client of a law firm or an attorney at a law firm or a docketing administrator, and so forth. As depicted next at block 410, an authorized party (i.e., the user) can be provided with secure and remote access to the docket matters based on the secure identification. The secure identification can be entered via the remote client as indicated at block 412. The remote access is read-only as indicated at block 414. The remote access to the docket matters can include access to scanned images of documents including, for example, a file wrapper associated with the docket matters, as depicted at block 416.

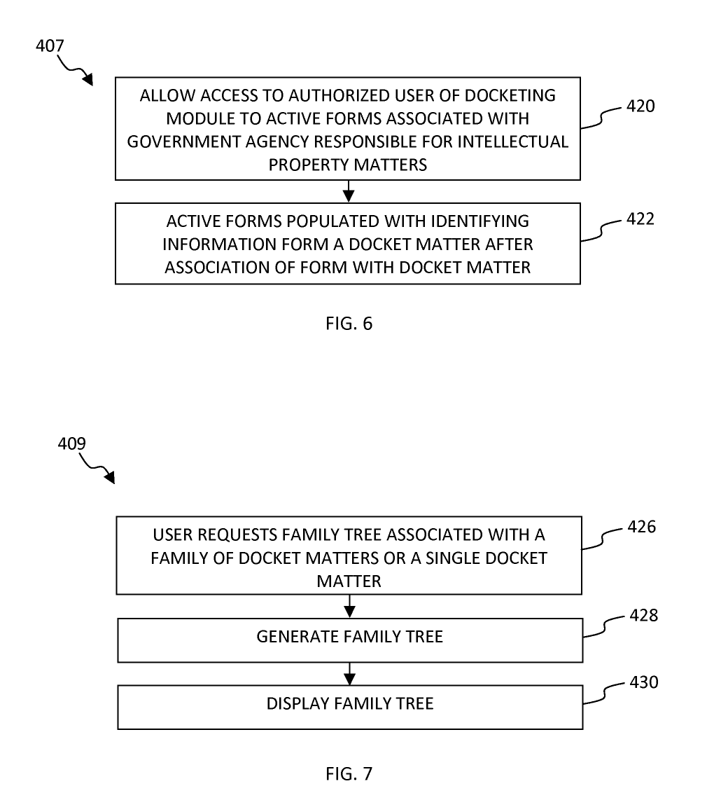

FIG. 6 illustrates a high-level flow chart depicting additional logical operational steps of a docketing and management method 407, in accordance with the disclosed embodiments. As indicated at block 418 in FIG. 6, an operation can be implemented to permit access to an authorized user of the docketing module to one or more active forms associated with a government agency responsible for intellectual property matters. Such forms are accessible from the network server via the docketing module, as indicated at block 420. As illustrated next at block 422, active form(s) can be populated with identifying information from a docket matter after association of the active form(s) with the docket matter.

FIG. 7 illustrates a high-level flow chart depicting additional logical operational steps of a docketing and management method 409, in accordance with the disclosed embodiments. As indicated at block 426, a user can request generation of a family tree associated with a family of docket matters in response to a particular input. As indicated next at block 428, the family tree is generated and then as indicated at block 430, displayed for the user. The family tree generated and displayed is based on a family of docket matters. For example, a “family” of docket matters may include a parent patent application followed by several “child” applications such as a first continuation patent application, a second continuation application, a CIP (Continuation in Part) patent application based on the first continuation patent application and so forth. Such a family tree can be thus generated and then displayed for a user via a display such as display screen of a computer workstation, laptop computer, Smartphone, and so forth. Docket matters can include, for example, patent related docket matters and the aforementioned family tree can be rendered based on docketing matter filing dates and continuation status and other data such as issue dates, titles, filing information, bar dates, due dates, priority dates and so forth.

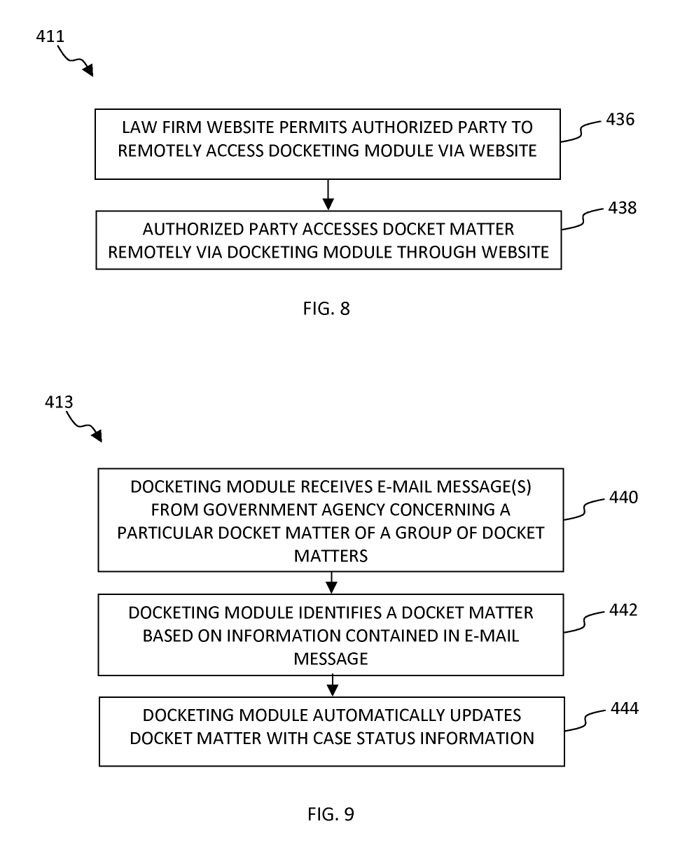

FIG. 8 illustrates a high-level flow chart depicting additional logical operational steps of a docketing and management method 411, in accordance with the disclosed embodiments. As indicated at block 436, a law firm can establish a website that permits an authorized party (e.g., a law firm client) remote access to the docketing module via the law firm website. The aforementioned authorized party may be a client of a law firm. The authorized party then accesses a docket matter and/or a family of docket matters via the docketing module, as indicated at block 438. The website is associated with the law firm and/or hosted/sponsored by the law firm or an appropriate website hosted by an Internet Service Provider (ISP) on behalf of the law firm.

FIG. 9 illustrates a high-level flow chart depicting additional logical operational steps of a docketing and management method 413, in accordance with the disclosed embodiments. As indicated at block 440, the docketing module can receive at least one e-mail message regarding case status from a government agency. For example, the government agency may be the U.S. Patent & Trademark Office and the e-mail message may be a PAIR notification from the U.S. Patent & Trademark Office concerning a particular docket matter and hence, a particular patent application on file with the U.S. Patent & Trademark Office. Next, as indicated at block 442, the docketing module can identify a docket matter from the e-mail message based on identifying information, such as, for example, at least one of a serial number or a docket number. Thereafter, as depicted at block 444, the docketing module can automatically update a docket matter with case status information.

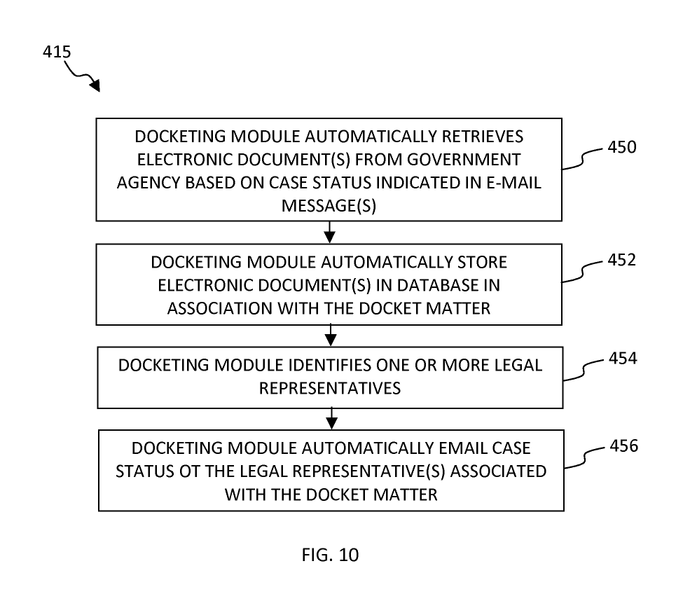

FIG. 10 illustrates a high-level flow chart depicting additional logical operational steps of a docketing and management method 415, in accordance with the disclosed embodiments. As indicated at block 450, the docketing module can automatically retrieve one or more electronic documents from a government agency based on a case status provided by one or more e-mail messages and then, as depicted at block 452, store the electronic document(s) in a database in association with the docket matter. Next, as indicated at block 454, the docketing module can identify one or more legal representatives (e.g., patent attorneys, patent agents, paralegals, etc) responsible for the docket matter and then as depicted at block 456, automatically e-mail the case status to the legal representative. The docketing module can be configured to identify one or more legal representative responsible for the docket matter and automatically e-mail the case status to the legal representative(s) along with the electronic document(s) retrieved from the government agency. Additionally, the docketing module can be configured to receive e-mail messages regarding case status from a government agency, identify a docket matter from the e-mail message based on a serial number or a docket number, and identify a responsible legal representative to be notified regarding the case status and then automatically update the docket matter with the case status.

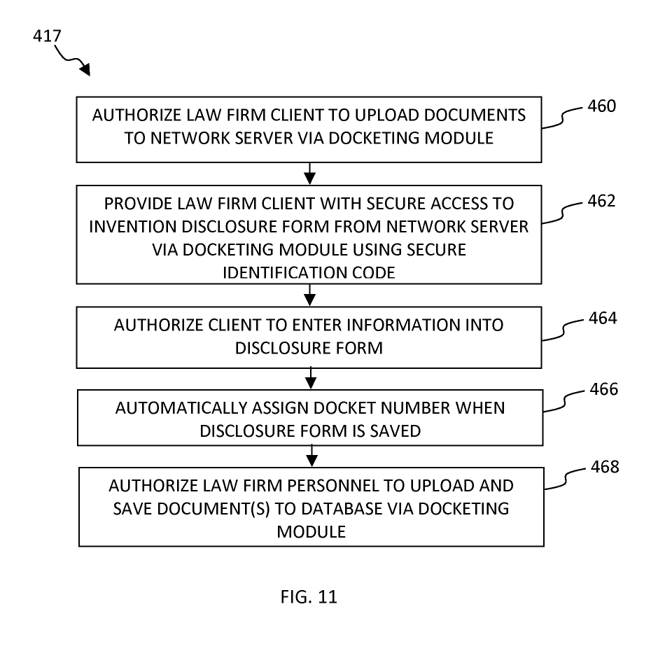

FIG. 11 illustrates a high-level flow chart depicting additional logical operational steps of a docketing and management method 417, in accordance with the disclosed embodiments. As indicated at block 460, a law firm client can be authorized to upload to the network server via the docketing module, one or more documents associated with one or more docket matters, wherein the docket matter (s) is associated with the law firm client. Then, as indicated at block 462, the preauthorized law firm client can also be provided with secure access an electronic invention disclosure form via the docketing module from the law firm website using a secure identification code such as a password, username, etc. Next, as indicated at block 464, the preauthorized law firm client can be authorized via the docketing module to enter information regarding a new invention into the electronic invention disclosure form. Then, as illustrated at block 466, a new docket number can be automatically assigned to the electronic invention disclosure form when the electronic invention disclosure form is saved in the database via the docketing module. In an alternative embodiment, an optional step can be implemented, as indicated at block 468 in which authorized law firm personnel can be permitted, via the docketing module, to upload and save an electronic document to the database, wherein the electronic document is associated with at least one docket matter among the aforementioned docket matters.

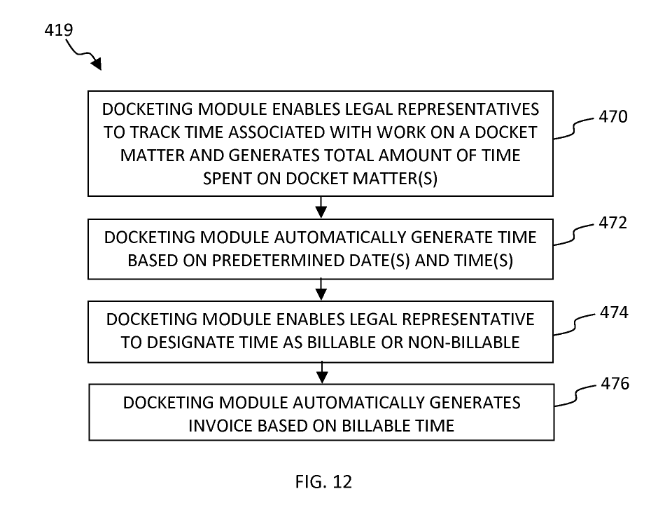

FIG. 12 illustrates a high-level flow chart depicting additional logical operational steps of a docketing and management method 405, in accordance with the disclosed embodiments. As indicated at block 419, the docketing module can track the time of law firm personnel associated with work on a docket matter or a group of docket matters. As illustrated next at block 472, the docketing module can generate a total amount of time spent on one or more docket matters at predetermined date(s) and time(s). The docketing module can then designate such time as constituting billable time or non-billable time as illustrated at block 474. An invoice can be then automatically generated as indicated at block 476 and sent to a client of the law firm based on the billable time as depicted at block 478.

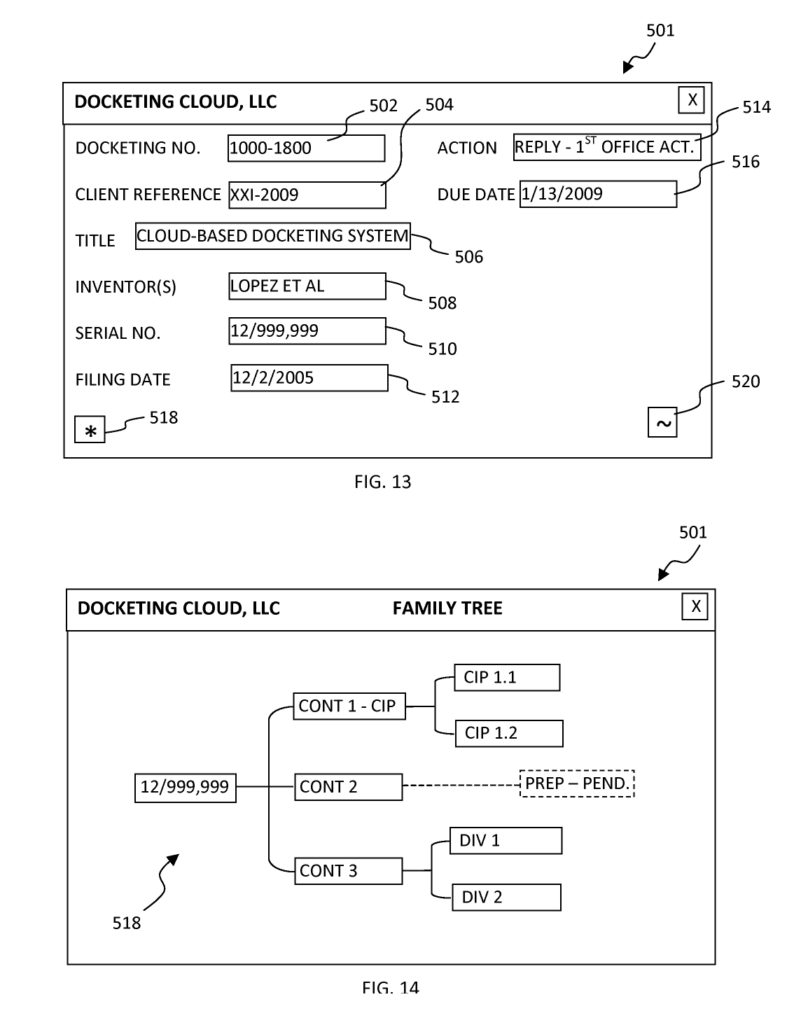

FIG. 13 illustrates a pictorial representation of a browser 501 configured to display a docketing application, in accordance with the disclosed embodiments. In the illustration depicted in FIG. 13, the docketing system is labeled as “Docket Cloud, LLC” and includes fields for entering data concerning a particular docket matter. For example, a docket number can be assigned and entered to a particular matter via entry field 502. A particular client reference number can be entered via entry field 504. The title of the matter (e.g., the title of a patent application) can be entered via entry field 506. Additionally, a serial number can be entered via entry field 508. A filing date can be entered via entry field 510 and an action item (e.g., response to an office action, prepare a patent application, file an appeal brief, etc) can be input via entry field 512. A due date can be entered via entry field 514. Data entered can then be saved by “clicking” with a mouse or other input device, the “save” button 517. A family tree as discussed herein earlier can be generated and displayed by selecting the graphical tree button 516. When the graphical tree button 516 is selected the tree is displayed via another browser window, for example, as shown in FIG. 14, which depicts a family tree 518 displayed within browser 514. The family tree 518 shown in FIG. 14 represents an example of a family of patent matters, including a parent patent application and various “child” applications such as divisional, continuation and CIP applications.

Browser 501 is a software application for retrieving, presenting, and traversing information resources on the World Wide Web. An information resource is identified by a Uniform Resource Identifier (URI) and may be a web page, image, video, or other pieces of content. Hyperlinks present in resources enable users to easily navigate browser 501 to related resources. Although browsers are primarily intended to access the World Wide Web, browser 501 can also be used to access information provided by Web servers in private networks or files in file systems. Browser 501 can also be configured for use to for saving information resources to file systems.

FIG. 15 illustrates a block diagram of a cloud-based docketing system 600, which includes the use of a docketing module 152 (e.g., application module 152 discussed earlier), which may be hosted by a third-party server/provider, which communicates via the Internet “cloud” or network 302 with various users/parties, such as, for example, a boutique patent law firm 604, an in-house law department 602 of a company or organization, and/or a solo practitioner 606, a law firm represented client, and so forth. Thus, the docketing system and method disclosed herein can be implemented as a cloud-based docketing system and method. Note that the term “cloud” as utilized herein generally refers to cloud based computing and hence network 302. That is, the disclosed embodiments are implemented via “could computing,” which is a technology used to access services offered on the Internet cloud. Everything an informatics system has to offer is provided as a service, so users can access these services available on the “Internet cloud” 302 without having any previous know-how (or at least not as an expert) on managing the resources involved. The disclosed docketing module 152 is preferably offered as SaaS (Software as a Service), which is a model of software deployment whereby a provider licenses an application to customers for use as a service on demand. SaaS software vendors may host the application on their own web servers or upload the application to the consumer device, disabling it after use or after the on-demand contract expires. The on-demand function may be handled internally to share licenses within a firm or by a third-party application service provider (ASP) sharing licenses between firms.

As indicated earlier the “Internet cloud” or network 302 generally communicates with one or more servers, such as, for example, server 304 and 306 illustrated herein with respect to FIG. 3. Server 304 and server 306 and other servers (not shown) can be configured to act as redundant servers. That is, servers 304 and 306 (and other servers) can communicate with one another via the “cloud” or network 302 (e.g., see the Internet cloud 302 shown in FIG. 15). In this manner, data stored in server 304 can be synchronized with data stored in server 306 and/or other servers, so that if one server goes down the other server or servers can contain the same data and one does not need to worry about a loss of data. In some embodiments, server 304 may be located geographically in a distant location (e.g., the East Coast) from the other server 306 located at a different position (e.g., the West Coast). Such servers can be implemented as SaaS servers run by a particular organization such as the organization providing the disclosed method and system for a client, such as a law firm, a solo practitioner, etc. Such servers may host a database 154, for example, which can contain docketing data. Note that database 154 is analogous or similar to the storage unit 308 depicted in FIG. 3.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A docketing and management method, said method comprising:
associating a network server with an SaaS docketing module and a database for storing docket matters, by executing a program instruction in a data-processing system;
accessing said network server over a data network via at least one remote client to enter, update and review, via said docketing module, the status of docket matters sorted and stored in said database by said docketing module by at least a client name, a client docket number, an activity and a target date for completion of said activity, by executing a program instruction in a data-processing system; and
automatically delivering a client matter status at predetermined intervals via network automated and electronic delivery from said network server to said at least one remote client via said docketing module, by executing a program instruction in a data-processing system.

2. The method of claim 1 further comprising:
establishing a secure identification with a family of said docket matters stored in said database, by executing a program instruction in a data-processing system; and
providing an authorized party secure and remote access to said family of docket matters based on said secure identification, wherein said secure identification is entered via said at least one remote client and wherein said remote access is read-only, by executing a program instruction in a data-processing system.

3. The method of claim 2 wherein said remote access to said family of said docket matters includes scanned images of documents comprising a file wrapper associated with at least one of said docket matters, by executing a program instruction in a data-processing system.

4. The method of claim 1 providing access to at least one active form associated with a government agency responsible for intellectual property matters, said at least one active form accessible from said network server via said docketing module, by executing a program instruction in a data-processing system.

5. The method of claim 1 providing access to at least one active form associated with a government agency responsible for intellectual property matters, said at least one active form accessible from said network server via said docketing module and wherein said at least one active form is populated with identifying information from a particular docket matter among said docket matters after association of said at least one active form with said particular docket matter, by executing a program instruction in a data-processing system.

6. The method of claim 2 further comprising generating a family tree associated with said family of said docket matters, by executing a program instruction in a data-processing system.

7. The method of claim 6 wherein said docket matters comprises patent related docket matters and said family tree is rendered based on docketing matter filing dates and continuation status, by executing a program instruction in a data-processing system.

8. The method of claim 3 wherein said authorized party comprises a client of a law firm and wherein said remote access to said family of docket matters is provided to said client of said law firm via a website associated with said law firm, by executing a program instruction in a data-processing system.

9. The method of claim 1 further comprising configuring said docketing module to receive at least one e-mail message regarding case status from a government agency, identify a docket matter from said at least one e-mail message based on at least one of a serial number or docket number, and automatically update said docket matter with said case status, said docket matter among said docket matters, by executing a program instruction in a data-processing system.

10. The method of claim 9 further comprising further configuring said docketing module to automatically retrieve at least one electronic document from said government agency based on said case status provided by said at least one e-mail message and store said at least one electronic document in said database in association with said docket matter, by executing a program instruction in a data-processing system.

11. The method of claim 10 further comprising configuring said docketing module to identify at least one legal representative responsible for said docket matter and automatically e-mail said case status to said at least one legal representative, by executing a program instruction in a data-processing system.

12. The method of claim 10 further comprising configuring said docketing module to identify at least one legal representative responsible for said docket matter and automatically e-mail said case status to said at least one legal representative and said electronic document retrieved from said government agency, by executing a program instruction in a data-processing system.

13. The method of claim 1 further comprising configuring said docketing module to receive e-mail messages regarding case status from a government agency, identify a docket matter from said e-mail message based on at least one of a serial number or docket number, and identify a responsible legal representative to be notified regarding said case status and automatically update said docket matter with said case status, said docket matter among said docket matters, by executing a program instruction in a data-processing system.

14. The method of claim 1 further comprising authorizing a law firm client to upload to said network server via said docketing module, at least one document associated with at least one docket matter among said docket matters, wherein said at least one docket matter is associated with said law firm client, by executing a program instruction in a data-processing system.

15. The method of claim 1 further comprising:
allowing a preauthorized law firm client to access an electronic invention disclosure form via said docketing module from a law firm website using a secure identification code, by executing a program instruction in a data-processing system;
permitting said preauthorized law firm client to enter information regarding a new invention into said electronic invention disclosure form, by executing a program instruction in a data-processing system; and
assigning a new docket number to said electronic invention disclosure form when said electronic invention disclosure form is saved in said database and via said docketing module, by executing a program instruction in a data-processing system.

16. The method of claim 1 further comprising permitting authorized law firm personnel to upload and save an electronic document to said database, wherein said electronic document is associated with at least one docket matter among said docket matters, by executing a program instruction in a data-processing system.

17. The method of claim 1 further comprising configuring said docketing module to track a time of law firm personnel associated with work on at least one docket matter among said docket matters, by executing a program instruction in a data-processing system.

18. The method of claim 17 further comprising configuring said docketing module to generate a total amount of time spent on said at least one docket matter at a predetermined date and time, by executing a program instruction in a data-processing system.

19. The method of claim 17 further comprising designating said time spent as billable time or non-billable time, by executing a program instruction in a data-processing system.

20. The method of claim 19 further comprising automatically generating an invoice to a client of a law firm based on said billable time, by executing a program instruction in a data-processing system.

21. A docketing and management system, said system comprising:
a processor;
a data bus coupled to said processor; and
a computer-usable medium embodying computer code, said computer-usable medium being coupled to said data bus, said computer program code comprising instructions executable by said processor and configured for:
accessing a network server over a data network via at least one remote client to enter, update and review via an SaaS docketing module, the status of docket matters sorted and stored in a database by said docketing module by at least a client name, a client docket number, an activity and a target date for completion of said activity; and
automatically delivering a client matter status at predetermined intervals via network automated and electronic delivery from said network server to said at least one remote client via said docketing module.

22. The system of claim 21 wherein said instructions are further configured for:
establishing a secure identification with a family of said docket matters stored in said database; and
providing an authorized party secure and remote access to said family of docket matters based on said secure identification, wherein said secure identification is entered via said at least one remote client and wherein said remote access is read-only.

23. The system of claim 22 wherein said remote access to said family of said docket matters includes scanned images of documents comprising a file wrapper associated with at least one of said docket matters.

24. The system of claim 21 wherein said instructions are further configured for providing access to at least one active form associated with a government agency responsible for intellectual property matters, said at least one active form accessible from said network server via said docketing module.

25. The system of claim 21 wherein said instructions are further configured for providing access to at least one active form associated with a government agency responsible for intellectual property matters, said at least one active form accessible from said network server via said docketing module and wherein said at least one active form is populated with identifying information from a particular docket matter among said docket matters after association of said at least one active form with said particular docket matter.

26. The system of claim 22 wherein said instructions are further configured for generating a family tree associated with said family of said docket matters.

27. The system of claim 26 wherein said docket matters comprise patent related docket matters and said family tree is rendered based on docketing matter filing dates and continuation status.

28. The system of claim 23 wherein said authorized party comprises a client of a law firm and wherein said remote access to said family of docket matters is provided to said client of said law firm via a website associated with said law firm.

29. The system of claim 21 further comprising configuring said docketing module to receive at least one e-mail message regarding case status from a government agency, identify a docket matter from said at least one e-mail message based on at least one of a serial number or docket number, and automatically update said docket matter with said case status, said docket matter among said docket matters.

30. The system of claim 29 further comprising further configuring said docketing module to automatically retrieve at least one electronic document from said government agency based on said case status provided by said at least one e-mail message and store said at least one electronic document in said database in association with said docket matter.

31. The system of claim 30 further comprising configuring said docketing module to identify at least one legal representative responsible for said docket matter and automatically e-mail said case status to said at least one legal representative.

32. The system of claim 30 further comprising configuring said docketing module to identify at least one legal representative responsible for said docket matter and automatically e-mail said case status to said at least one legal representative and said electronic document retrieved from said government agency.

33. The system of claim 21 wherein said instructions are further configured for permitting said docketing module to receive e-mail messages regarding case status from a government agency, identify a docket matter from said e-mail message based on at least one of a serial number or docket number, and identify a responsible legal representative to be notified regarding said case status and automatically update said docket matter with said case status, said docket matter among said docket matters.

34. The system of claim 21 wherein said instructions are further configured for authorizing a law firm client to upload to said network server via said docketing module, at least one document associated with at least one docket matter among said docket matters, wherein said at least one docket matter is associated with said law firm client.

35. The system of claim 21 wherein said instructions are further configured for:
allowing a preauthorized law firm client to access an electronic invention disclosure form via said docketing module from a law firm website using a secure identification code;
permitting said preauthorized law firm client to enter information regarding a new invention into said electronic invention disclosure form; and
assigning a new docket number to said electronic invention disclosure form when said electronic invention disclosure form is saved in said database and via said docketing module.

36. The system of claim 21 wherein said instructions are further configured for permitting authorized law firm personnel to upload and save an electronic document to said database, wherein said electronic document is associated with at least one docket matter among said docket matters.

37. The system of claim 21 wherein said instructions are further configured for tracking, via said docketing module, a time of law firm personnel associated with work on at least one docket matter among said docket matters.

38. The system of claim 27 wherein said instruction are further configured for generating, via said docketing module, a total amount of time spent on said at least one docket matter at a predetermined date and time.

39. The system of claim 27 wherein said instructions are further configured for designating said time spent as billable time or non-billable time.

40. The system of claim 29 wherein said instructions are further configured for automatically generating an invoice to a client of a law firm based on said billable time.
